(19) United States
(12) Patent Application Publication
(10) Pub. No.: US 2006/0169645 A1
(43) Pub. Date: Aug. 3, 2006

(54) Water treatment systems and techniques principally for use on-board aircraft

(76) Inventor: Angela M. Hsueh, Diamond Bar, CA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/048,034

(22) Filed: Jan. 31, 2005

(51) Int. Cl. C02F 1/00

(52) U.S. Cl. 210/739

(57) ABSTRACT

Water-treatment systems and techniques are addressed. These systems and techniques contemplate monitoring water-quality-related information and creating residual disinfectant in recirculating water loops. Such circulating residuals also may help control biofilm otherwise likely to be present in the conduits and other equipment through which the water passes. Heaters may be employed as parts of the systems, and pressure differentials may be exploited to control water flow. Principally for use on-board aircraft operable at substantial altitude, the systems and methods may nevertheless be utilized in other vehicles or vessels or otherwise as appropriate or desired.

### FIELD OF THE INVENTION

This invention relates to systems and techniques for treating water and more particularly, but not exclusively, to such systems and techniques implemented on-board commercial passenger or other aircraft.

### BACKGROUND OF THE INVENTION

According to the U.S. Environmental Protection Agency (“EPA” or “Agency”), more than twelve percent of passenger aircraft tested in the United States during August and September 2004 “carried water that did not meet EPA standards.” Water on-board these aircraft tested positive for total coliform bacteria, with some water also testing positive for E. coli bacteria. As noted by the EPA, “[b]oth total coliform and E. coli are indicators that other disease-causing organisms (pathogens) could be in the water and could potentially affect people's health.” See “Airline Water Supplies” at http:H/www.epa.gov/airlinewater.

On Nov. 9, 2004, EPA announced commitments from numerous U.S. passenger airlines “to implement new aircraft water testing and disinfection protocols.” Administrative agreements executed with these airlines require increased monitoring of water quality on-board commercial aircraft. They also require airlines to analyze possible sources of contamination existing outside their aircraft and “to provide information related to practices of boarding water from foreign public water supplies not regulated by EPA.” See “EPA Reaches Agreement with Major Airlines to Implement New Aircraft Water Protocols” at http://yosemite.epa.gov/opa.

Clear from EPA's recent public announcements is that improving water quality on-board passenger aircraft is an important objective of the Agency. Systems and techniques effecting such improvement thus may provide valuable tools to U.S. airlines as they seek to comply with the administrative agreements. They may also be useful to the EPA as it works to enhance the quality of drinking and other water made available to the public.

U.S. Pat. No. 4,871,452 to Kohler, et al., entitled “On-Board Water Supply,” discloses equipment for purifying waste water from galleys, sinks, and toilets of aircraft. Waste water from these areas discharges to a tank, after which it passes through a mechanical filter, a bed of active carbon, ozone and osmotic stages, and a disinfection stage involving addition of chlorine and irradiation with ultraviolet (“UV”) light. Thereafter, the water is made available to aircraft passengers for certain uses.

Discussed in U.S. Pat. No. 6,143,185 to Tracy, et al. are alternate systems for decontaminating waste water from aircraft toilets, sinks, and galleys. They too include a mechanical particulate filter, activated carbon, and a source of UV light. Alternatively, according to the Tracy patent, the waste water may be exposed to microwaves or treated with chlorine or iodine. A sensor may be used to measure “the level of clarity of the treated water as an indication of its purity” and restrict opening of a control valve until acceptable clarity levels are obtained. The entire contents of both the Kohler and Tracy patents are incorporated herein by this reference.

### SUMMARY OF THE INVENTION

The present invention provides different systems and techniques for treating water likely, among other things, to assist airlines in complying with their commitments to EPA. Monitoring of water-quality-related information other than clarity is contemplated as part of the present invention, as is creating residual disinfectant in recirculating water. This residual disinfectant may function not only to inhibit growth of bacteria in the water, but also to control biofilm otherwise likely to be present in the conduits and other equipment through which the water passes.

Pressure differentials may be used to force quantities of recirculating water out of the main recirculation loop and into a bypass area in which disinfection principally may occur. Use of pressure differentials may also result in more uniform placement of disinfected water within multiple holding tanks and greater temperature control of water within the tanks. Heaters additionally may be included in the systems both to reduce the possibility of water freezing within the conduits (particularly when used on-board aircraft at altitude) and as part of the disinfection process.

Consistent with the present invention, disinfectant may be generated on-board aircraft or other vehicles or vessels using electrolysis of salt water. By creating a system admitting residual disinfectant to be in the recirculating water, monitoring the amount of the residual in the recirculation loop may provide information relating to the quality of the water therein. Finally, the weight of any descaling device utilized as part of the innovative systems may be reduced by using magnetic alloys as shields.

It thus is an optional, non-exclusive object of the present invention to provide systems and techniques for treating water.

It also is an optional, non-exclusive object of the present invention to provide water-treatment systems and techniques for use on-board aircraft or other vehicles.

It is a further optional, non-exclusive object of the present invention to provide systems and techniques for monitoring water-quality related information, with such information preferably (but not necessarily) being or relating to amounts of residual disinfectant present in recirculating water.

It is another optional, non-exclusive object of the present invention to provide systems and techniques for controlling biofilm within recirculating water loops.

It is, moreover, an optional, non-exclusive object of the present invention to provide systems and techniques in which pressure differentials are utilized to control water flow into either or both of a disinfectant area and holding tanks.

It is yet another optional, non-exclusive object of the present invention to provide water-treatment systems and techniques in which heaters are used both to reduce the possibility of freezing and for disinfecting purposes.

It is an additional object of the present invention to provide systems and techniques in which magnetic alloys are used as shields of descaling devices.

Other objects, features, and advantages of the present invention will be apparent to those skilled in the relevant field with reference to the remaining text and the drawings of this application.

### BRIEF DESCRIPTION OF THE DRAWINGS

FIG. 1 is a schematic representation of an exemplary water-supply and -treatment system for an aircraft.

FIG. 2 is a schematic representation of a portion of the system of FIG. 1.

### DETAILED DESCRIPTION

1. Structure of the System

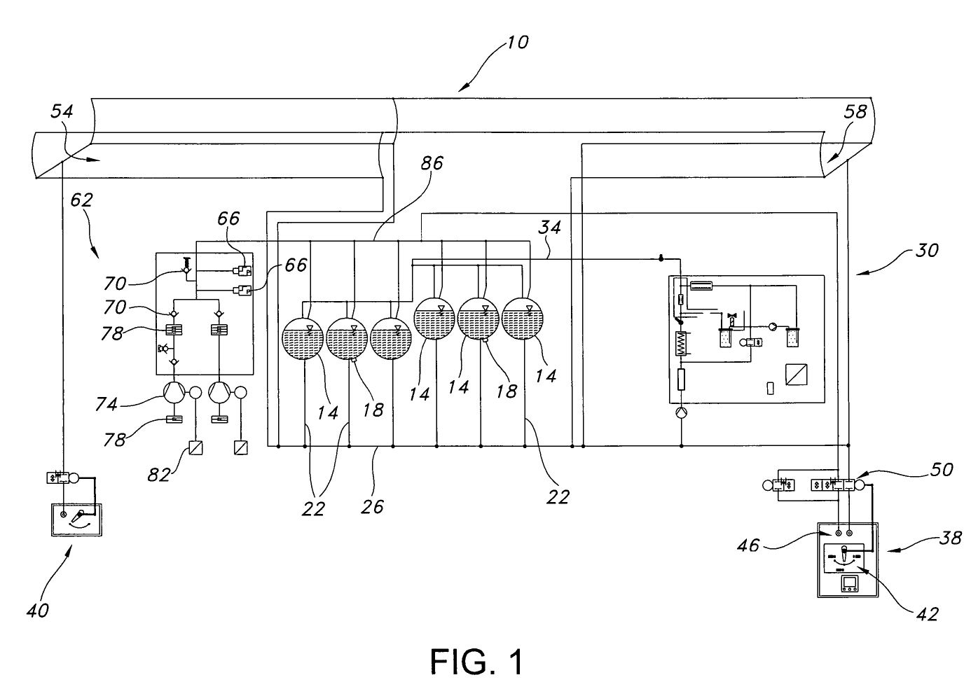

Illustrated schematically in FIG. 1 is an exemplary water-supply and -treatment system 10 consistent with the present invention. System 10 is designed especially for a commercial passenger aircraft. It is, however, not limited to use in these aircraft, but instead may be used in other aircraft, other vehicles, or otherwise as appropriate or desired.

Included in the system 10 shown in FIG. 1 are one or more tanks 14. Such tanks 14, of which six are detailed in FIG. 1, typically contain potable water for use by humans. If present in an aircraft, for example, the water may be used for any or all of drinking, cooking, or hygienic purposes. Sensors 18 present on any or all of tanks 14 may provide indication of one or more characteristics of water contained in associated tanks, including the amount (level) of water contained in a tank 14.

Also associated with tanks 14 are valves or other mechanisms capable of selectively allowing water to exit therefrom. Water exiting tanks 14 travels through conduit of drain lines 22 to distribution line 26. Thereafter, some of the water in distribution line 26 may travel directly to areas prepared for its use. As illustrated in FIG. 1, for example, water in line 26 may travel to any or all of the forward or aft main or upper decks of an aircraft for use by passengers and crew.

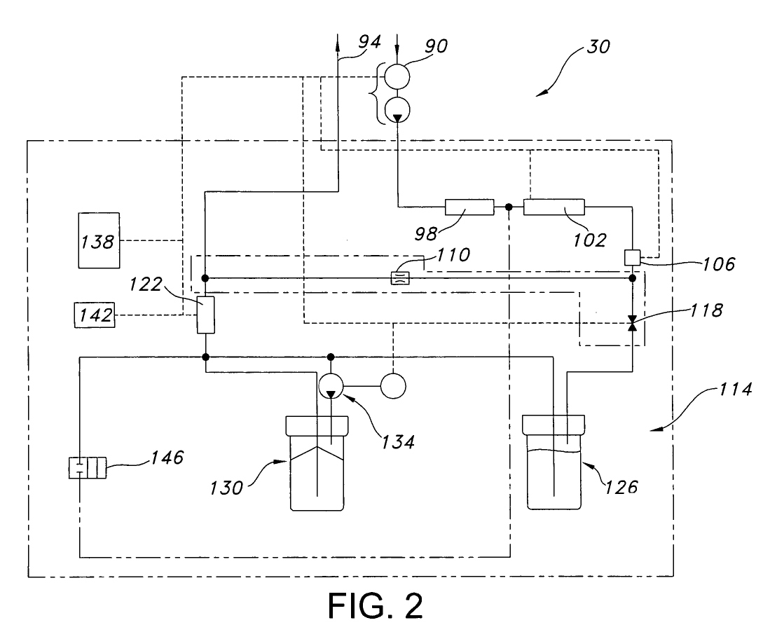

However, at least some water in line 26 is intended to travel to water-treatment module 30 shown in FIGS. 1-2. Module 30 effectively forms a by-pass disinfection loop, returning disinfected water to tanks 14. Such water does so through conduit forming circulation line 34, following which it reenters tanks 14 through, preferably (but not necessarily), appropriate valves.

Additionally schematically shown in FIG. 1 is optional equipment 38 and 40 useful for filling tanks 14 and draining both the tanks 14 and, possibly, any storage tanks in which waste water accumulates in flight. Equipment 38, for example, includes fill/drain switch 42 typically located on the external underside of an aircraft. Switch 42 may be manipulated by ground staff at an airport to permit tanks 14 either to be filled or emptied as appropriate. Equipment 38 also may include connectors 46, motors 50, and other devices adapted for creating or allowing fluid to flow. Equipment 40, by contrast, is designed solely to drain water. As detailed in FIG. 1, equipment 40 may be connected to forward water-distribution system 54 of an aircraft, while equipment 38 may be connected to either or both of tanks 14 and aft water-distribution system 58 of the aircraft.

FIG. 1 further illustrates ancillary equipment 62 useful in connection with the present invention. Equipment 62 may comprise any or all of such things as pressure switches 66, relief and check valves 70, compressors 74, filters 78, and controllers 82. Pressurized air produced by equipment 62 may flow through manifold 86 to tanks 14 so as to pressurize the water therein.

Illustrated in greater detail in FIG. 2 is water-treatment module 30 of the present invention. Module 30 receives water from distribution line 26 via circulation pump 90 and returns treated water to circulation line 34 via conduit 94. Incorporated into module 30 may be scaling-inhibition module 98 and heater 102. Preferably, although not necessarily, all water entering module 30 passes through or by both module 98 and heater 102 before returning to circulation line 34.

Also forming part of module 30 may be sensor 106 and flow restrictor 110. Although sensor 106, if present, may indicate any characteristic of the water flowing through module 30, it preferably provides information as to the amount of residual chlorine or other disinfectant contained in the water. Such information may be in the form of any or all of oxidation-reduction potential (ORP), pH, water temperature, or otherwise as desired.

Flow restrictor 110 provides a pressure differential designed to force at least some water through sanitization section 114 when stop valve 118 is open. Typically including an electrolytic cell 122, section 114 also may include resin cartridge 126, brine cartridge 130, and brine pump 134. Passage through resin cartridge 126 functions to soften water. While brine pump 134 is operating, a bypass of (pure) water flows into brine cartridge 130 and brine solution flows out of cartridge 130 and is diluted with fresh water to a concentration advantageous for electrolytic cell operation before flowing into electrolytic cell 122. Within cell 122, the brine solution is converted into mixed oxidants via electrolysis, with the mixed oxidants thereafter injected into line 34 via conduit 94.

Control unit 138 operates to control components of module 30. Additionally depicted in FIG. 2 are PTC ambient sensor 142, which functions to sense air temperature within module 30 during operation, and drain valve 146. Drain valve 146 permits drainage of the lines and conduit of module 30 when necessary or desired.

2. Selected Functions of the System

System 10 performs numerous supply and treatment functions. Module 30, for example, operates to decrease pathogens in a water supply passing through the module. However, it also may deposit residual disinfectant in the water so that disinfectant is carried by the circulating water throughout other components of system 10. This residual disinfectant thus may both inhibit growth of bacteria in the water throughout system 10 and control biofilm otherwise likely to be present in the conduits and other equipment of the system 10. Furthermore, monitoring one or more aspects of the residual disinfectant may be used to provide feedback as system 10 as to the quality of the water therein, with such feedback potentially used by control unit 138, via valve 118, to increase or decrease (as a function of time) the time during which valve 118 remains open, thereby affecting the amount of water shunted to sanitization section 114. This change in the amount of shunted water in turn will cause corresponding change in the amount of residual disinfectant in the circulating water, with such updated information likewise ultimately being provided to control unit 138.

System 10 also utilizes heat and pressure to facilitate the disinfection process. For example, not only does heater 102 assist in preventing circulating water from freezing, by heating the flowing water it also may assist some of the chemical reactions in which sanitization occurs. Pressurization of the water likewise may assist these reactions; it also may be employed to force quantities of water into the by-pass loop including sanitization section 114.

Moreover, controls associated with system 10 may use pressurization and differential pressures to cause water to flow relatively uniformly into tanks 14. Because tanks 14 may be connected in parallel to circulation line 34 and distribution line 26, providing approximately equal disinfectant residual in water entering each such tank 14 may be beneficial. This is particularly true for controlling biofilm in the tanks 14 and drain lines 22, which otherwise might not receive a desirable amount of disinfectant.

Commercially-available magnetic descaling products generally are unshielded or shielded with a heavy layer of, e.g., steel. This shielding causes the units to be bulky and heavy. Module 98, however, may comprise a shield made from a sheet of Netic S3-6 alloy (available from Magnetic Shield Corporation) or other magnetic alloys with similar characteristics to reduce the weight and size of the module 98.

The foregoing is provided for purposes of illustrating, explaining, and describing exemplary embodiments and certain benefits of the present invention. Modifications and adaptations to the illustrated and described embodiments will be apparent to those skilled in the relevant art and may be made without departing from the scope or spirit of the invention.

What is claimed is:

1. An aircraft comprising:
a. a supply of water for use and circulation on-board the aircraft; and
b. means for improving quality of the water, such means creating residual disinfectant in the water as it circulates.

2. An aircraft according to claim 1 further comprising means for monitoring an aspect of the water as it circulates.

3. An aircraft according to claim 2 in which the monitoring means monitors a characteristic of water selected from the group consisting of oxidation-reduction potential, pH, or temperature.

4. An aircraft according to claim 1 in which the water-quality improvement means forms part of a by-pass loop through which water circulates.

5. An aircraft according to claim 4 further comprising a flow restrictor for creating a pressure differential so that water may be biased to flow into the by-pass loop.

6. An aircraft according to claim 5 further comprising a valve selectively permitting water to flow into the by-pass loop.

7. An aircraft according to claim 6 further comprising (a) means for monitoring an aspect of water as it circulates and (b) a control unit for opening or closing the valve based on the monitored aspect.

8. An aircraft according to claim 1 in which the water-quality improvement means comprises a water heater also useful to inhibit freezing of the water.

9. An aircraft according to claim 1 in which the water-quality improvement means comprises an electrolytic cell.

10. An aircraft according to claim 9 in which the water-quality improvement means further comprises means for providing salt water to the electrolytic cell.

11. An aircraft according to claim 1 further comprising (a) at least one tank for storing the water and (b) conduit through which the water passes; and in which the residual disinfectant facilitates controlling biofilm in the tank and conduit.

12. A system for improving quality of water for use in a vessel other than a swimming pool or spa, comprising:
a. a supply of water for use and circulation in the vessel; and
b. means for improving quality of the water, such means creating residual disinfectant in the water as it circulates.

13. A system according to claim 12 further comprising means for monitoring an aspect of the water as it circulates.

14. A system according to claim 13 in which the monitoring means monitors a characteristic of water selected from the group consisting of oxidation-reduction potential, pH, or temperature.

15. A system according to claim 12 in which the water-quality improvement means forms part of a by-pass loop through which water circulates.

16. A system according to claim 15 further comprising a flow restrictor for creating a pressure differential so that water may be biased to flow into the by-pass loop.

17. A system according to claim 16 further comprising a valve selectively permitting water to flow into the by-pass loop.

18. A system according to claim 17 further comprising (a) means for monitoring an aspect of water as it circulates and (b) a control unit for opening or closing the valve based on the monitored aspect.

19. A system according to claim 12 in which the water-quality improvement means comprises a water heater also useful to inhibit freezing of the water.

20. A system according to claim 12 in which the water-quality improvement means comprises an electrolytic cell.

21. A system according to claim 20 in which the water-quality improvement means further comprises means for providing salt water to the electrolytic cell.

22. A system according to claim 12 further comprising (a) at least one tank for storing the water and (b) conduit through which the water passes; and in which the residual disinfectant facilitates controlling biofilm in the tank and conduit.

23. A method of improving quality of water contained in a vessel other than a swimming pool or spa, comprising:
a. providing a circulation system for the water;
b. providing a by-pass loop containing disinfection material; and
c. selectively permitting the water to flow through the by-pass loop.

24. A method according to claim 23 further comprising creating residual disinfectant in water exiting the by-pass loop and returning to the circulation system.

25. A method according to claim 24 further comprising monitoring an aspect of the residual disinfectant.

26. A method according to claim 25 in which the action of selectively permitting water to flow through the by-pass loop is based on information obtained through monitoring an aspect of the residual disinfectant.

27. An aircraft according to claim 1 in which the water is potable.

28. A system according to claim 12 in which the water is potable.

29. A method according to claim 23 in which the water is potable.

30. A method according to claim 23 in which the vessel comprises an aircraft.
